(19) United States
(12) Patent Application Publication
(10) Pub. No.: US 2010/0083470 A1
(43) Pub. Date: Apr. 8, 2010

(54) MICROPHONE HOLDER

(75) Inventor: Takashi MURATA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: KABUSHIKI KAISHA AUDIO-TECHNICA, Tokyo (JP)

(21) Appl. No.: 12/562,461

(22) Filed: Sep. 18, 2009

(30) Foreign Application Priority Data
Oct. 8, 2008 (JP) 2008-261713

(51) Int. Cl. H04R 1/04

(52) U.S. Cl. 24/3.12; 381/364

(57) ABSTRACT

A microphone holder includes a rotational shaft capable of fitting into a clamping unit of a holder base through pushing and opening tip ends of bent arms of the clamping unit. The rotational shaft of the microphone holder has, at an outer periphery of the rotational shaft, a plurality of smooth concave portions at different angular positions. The rotational shaft is stably fit into the clamping unit as convex portions of the clamping unit fit into the concave portions of the rotational shaft. An angle of the microphone holder can be adjusted through smooth rotation of the microphone holder accompanied by sliding between the convex portions of the holding unit and the concave portions of the rotational shaft. Thus, noise generated upon the adjusting can be substantially reduced. A user can easily adjust the direction of the microphone only through the rotation of the microphone holder.

### BACKGROUND OF THE INVENTION

1. Field of the Invention

The present invention relates to an improvement of a microphone holder preferably used upon wearing a lavaliere microphone such as a cylindrical capacitor microphone on a chest or a tie.

2. Description of the Related Art

In lectures, conferences, and the like, microphone holders holding lavaliere microphones are clipped onto clothes, ties, and the like of performers or lecturers so that the lavaliere microphones are unnoticeable.

Microphones capable of being clipped onto a subject are also called pin microphones. Performers and the like wearing the pin microphones can wirelessly transmit their voices (see, for example, Japanese Patent Application Laid-open No. 2003-199182).

A microphone holder holding a microphone is highly useful because it enables a user (a performer) to wirelessly transmit his or her voice. However, with the microphone holder clipped onto the user in which the sound collecting direction is not directed to the mouth of the user, the user's voice may not be transmitted appropriately. Even with non-directional microphones, as well as with directional microphones, the above problem arises upon collecting voices or sounds in the high-tone range.

Since when wearing the microphone holder on their chest or the like, the outfit of users usually changes from occasion to occasion or according to each user' s taste, a position or a part of clothes and the like at which the microphone holder is to be attached is difficult to be specified.

A sound collecting direction may fail to be directed to the user' s mouth upon actual use even if a position of the microphone holder clipped on to the user' s chest has been determined upon attaching by setting an angle of the microphone (sound collecting direction).

Moreover, as edges of clothes or the like to which the microphone holders are clipped have various shapes, with a microphone holder having direction of a microphone mounted thereto fixed, setting of the position to be clipped is difficult. Further, during use, the microphone holder may be moved from its original clipped position or may fall off.

A microphone holder to solve the problem is known that has a holder base between a clip and a microphone holding unit to which a microphone is mounted. With this configuration, an angular positional relationship between the holder base and the microphone holding unit can be adjusted. Therefore, an angular positional relationship between the microphone and the clip can be adjusted as needed.

Example of such conventional microphone holder described in the above paragraph is shown in FIGS. 12 and 13. As shown in the figures, a lavaliere microphone 1 is held by a U-shaped elastic microphone holding unit 2 that holds the lavaliere microphone 1, and the microphone holding unit 2 is connected to a plate-shaped holder base 3. The plate-shaped holder base 3 is fixed to a clip 4 with a small bolt 4a.

The clip 4 has a shape of a tie-pin and can be detachably attached to an edge of a user' s clothes and the like with a spring pressure of a spring 4b.

FIG. 14 is a cross sectional view taken in the direction of arrows I-I of FIG. 12. A combinational structure of the microphone holding unit 2 and the holder base 3 is described with reference to FIG. 14.

As shown in FIG. 14, the microphone holding unit 2 and the holder base 3 are connected via a loosely inserted bolt shaped connecting fitting 5 having a shaft (rotational shaft) 5a penetrating through the microphone holding unit 2 and the microphone holder base 3 in the direction of a rotational center axis (Z). A spring 6 is disposed between the shaft 5a and the microphone holding unit 2 at the side of the shaft 5a closer to the microphone holding unit 2. As the spring 6 is compressed, the microphone holding unit 2 is constantly spring-urged to the holder base 3.

Thus, by pulling the microphone holding unit 2 in the direction of an arrow Y1 against the force applied by the spring 6, the microphone holding unit 2 can be pulled off from the holder base 3. As the microphone holding unit 2 is elastic and has a U-shape, the microphone 1 is mounted to the microphone holding unit 2 through pushing in the direction of an arrow Y2.

FIG. 15 is a cross sectional view taken in the direction of arrows II-II of FIG. 14. As shown in FIG. 15, the holder base 3 has, at a front side thereof, eight concave portions 3a having angular intervals of 45° to radiate outwardly from the inserted shaft 5a.

FIG. 16 is a cross sectional view taken in the direction of arrows III-III of FIG. 14. As shown in FIG. 16, the microphone holding unit 2 has, at a rear side thereof, four convex portions 2a having angular intervals of 90° around the rotational center axis (Z) to radiate therefrom. The convex portions 2a correspond to the concave portions 3a of the holder base 3.

Accordingly, the microphone holding unit 2 and the holder base 3 are connected by means of the spring 6 as the convex portions 2a of the microphone holding unit 2 fit into the concave portions 3a of the holder base 3. In FIG. 14, a numeral d denotes the height of the convex portions 2a of the microphone holding unit 2.

To adjust a relative angle (direction) of the microphone holding unit 2 holding or not holding the microphone 1 with respect to the holder base 3 (or the clip 4), a user pulls out the microphone holding unit 2 in the direction of an arrow Y1 against the force applied by the compressed spring 6 for more than the height d of the convex portions 2a. Thus, the convex portions 2a of the microphone holding unit 2 are taken out from the concave portions 3a of the holder base 3 as shown in FIG. 17.

After the convex portions 2a of the microphone holding unit 2 are taken out from the concave portions 3a of the holder base 3, the user rotates the microphone holding unit 2 about the rotational center axis (Z) (in direction of an arrow R in FIG. 17). At a new angular position of the microphone holding unit 2, with the spring force of the spring 6, the microphone holding unit 2 and the holder base 3 are connected as the convex portions 2a of the microphone holding unit 2 are set to fit the concave portions 3a of the holder base 3.

FIG. 18 depicts a state of the microphone holding unit 2 connected to the holder base 3 after being rotated leftward as viewed in the figure (counter clockwise) for 45° from its position shown in FIG. 12. FIGS. 19 and 20 are cross sectional views respectively depicting the microphone holding unit 2 and the holder base 3 connected as described in the preceding sentence. FIGS. 19 and 20 correspond to FIGS. 15 and 16, respectively.

As described above, with the conventional microphone holder, to adjust the relative angular positional relationship between: the microphone 1 or the microphone holding unit 2 holding the microphone 1; and the holder base 3 (or the clip 4) connected to the microphone holding unit 2, the microphone holding unit 2 is pulled out from the holder base 3 against the force applied by the spring 6, rotated about the rotational axis, and then the convex portions 2a of the microphone holding unit 2 are fit into the concave portions 3a of the holder base 3.

The conventional microphone holder has a complex structure as the microphone holding unit 2 and the holder base 3 are connected via the loosely inserted connecting fitting 5 provided with the spring 6. Moreover, the user is obliged to: pull off the microphone holding unit 2 from the holder base 3 against the force applied by the spring 6; and rotate the microphone holding unit 2.

Further, the microphone holding unit 2 and the holder base 3 are connected by means of the spring force of the spring 6 as the convex portions 2a of the microphone holding unit 2 are dropped into the concave portions 3a of the holder base 3 to be received therein. Thus, a considerable collision sound is generated between the microphone holding unit 2 and the holder base 3 or clicking sound is generated as the convex portions 2a fit the concave portions 3a. Such sounds are picked up by the microphone 1 to be transmitted as a large noise. Thus, the improvement is called for.

### SUMMARY OF THE INVENTION

In view of the above, an object of the present invention is to provide a microphone holder with a simple structure that enables a user to easily adjust a relative angular positional relationship between a microphone holding unit and a holder base while reducing the noise generation.

### Means for Solving the Problem

A first aspect of the present invention is a microphone holder including a clip fixed to a plate-shaped holder base and a microphone holding unit connected to the holder base and capable of holding a microphone, wherein the holder base has a bent clamping unit having bent arms of which facing tip ends each having a convex portion, the microphone holding unit has a rotational shaft capable of fitting into the clamping unit of the holder base by pushing and opening the tip ends of the bent arms, and the rotational shaft has a plurality of concave portions on a peripheral surface of the rotational shaft that can receive the convex portion of the clamping unit at various rotational angular positions of the rotational shaft.

A second aspect of the present invention is a microphone holder including a clip fixed to a plate-shaped holder base and a microphone holding unit connected to the holder base and capable of holding a microphone, wherein the holder base has a U-shaped clamping unit opening at one end of a longitudinal direction and having a convex portion at a rear surface of the holder base, and the microphone holding unit includes: a rotational shaft that can be fit into the U-shaped clamping unit of the holder base; and a flange having a plurality of concave portions circumferentially arranged to be able to receive the convex portion of the U-shaped clamping unit at various rotational angular positions of the rotational shaft.

As described above, in the microphone holder according to the fist aspect of the present invention, the holder base has the bent clamping unit having the bent arms provided with the convex portion and the rotational shaft of the microphone holding unit has a plurality of concave portions on the peripheral surface of the rotational shaft that can receive the convex portion of the clamping unit at various rotational angular positions of the rotational shaft. Thus, the relative angular positional relationship between the microphone holding unit and the holder base can be adjusted easily only through a smooth sliding. Therefore, with its simple structure, noise generation can be substantially reduced.

In the microphone holder according to the second aspect of the present invention, the holder base has the U-shaped clamping unit having the convex portion and the rotational shaft of the microphone holding unit has the flange having the concave portions circumferentially arranged to be able to receive the convex portion of the U-shaped clamping unit at various rotational angular positions of the rotational shaft. Thus, the relative angular positional relationship between the microphone holding unit and the holder base can be adjusted easily only through a smooth sliding. Therefore, with its simple structure, noise generation can be substantially reduced.

### BRIEF DESCRIPTION OF THE DRAWINGS

FIG. 1 is a plan view of a microphone holder of a first embodiment of the present invention;

FIG. 2 is a cross sectional view taken in the direction of arrow IV-IV of the microphone holder shown in FIG. 1;

FIG. 3 is a enlarged view of a main part in the cross sectional view of FIG. 2;

FIG. 4 is a front view of a holder base shown in FIG. 3;

FIG. 5 is a plan view of the microphone holder shown in FIG. 1 in which an angle of a microphone holding unit is adjusted;

FIG. 6 is plan view of a microphone holder of a second embodiment of the present invention;

FIG. 7 is a plan view of the microphone holder shown in FIG. 6;

FIG. 8 is a front view of the holder base shown in FIG. 6;

FIG. 9 is a plan view depicting an operating state of the holder base shown in FIG. 7;

FIG. 10 is a plan view of the microphone holding unit shown in FIG. 7;

FIG. 11 is a cross sectional view taken in the direction of arrows V-V of FIG. 10;

FIG. 12 is a front view of a conventional microphone holder;

FIG. 13 is a plan view of the microphone holder shown in FIG. 12;

FIG. 14 is a cross sectional view taken in the direction of arrows I-I of the microphone holder shown in FIG. 12;

FIG. 15 is a cross sectional view taken in the direction of arrows II-II of the microphone holder shown in FIG. 14;

FIG. 16 is a cross sectional view taken in the direction of arrows III-III of the microphone holder shown in FIG. 14;

FIG. 17 is a cross sectional view of the microphone holder shown in FIG. 14 upon pulling out a microphone holding unit;

FIG. 18 is a plan view of a main part of the microphone holder shown in FIG. 12 with an angle of the microphone holding unit adjusted;

FIG. 19 is a cross sectional view depicting a state in which an angle of a microphone holding unit is adjusted from an angle depicted in FIG. 15; and

FIG. 20 is a cross sectional view depicting a state in which an angle of a microphone holding unit is adjusted from an angle depicted in FIG. 16.

### DETAILED DESCRIPTION OF THE PREFERRED EMBODIMENTS

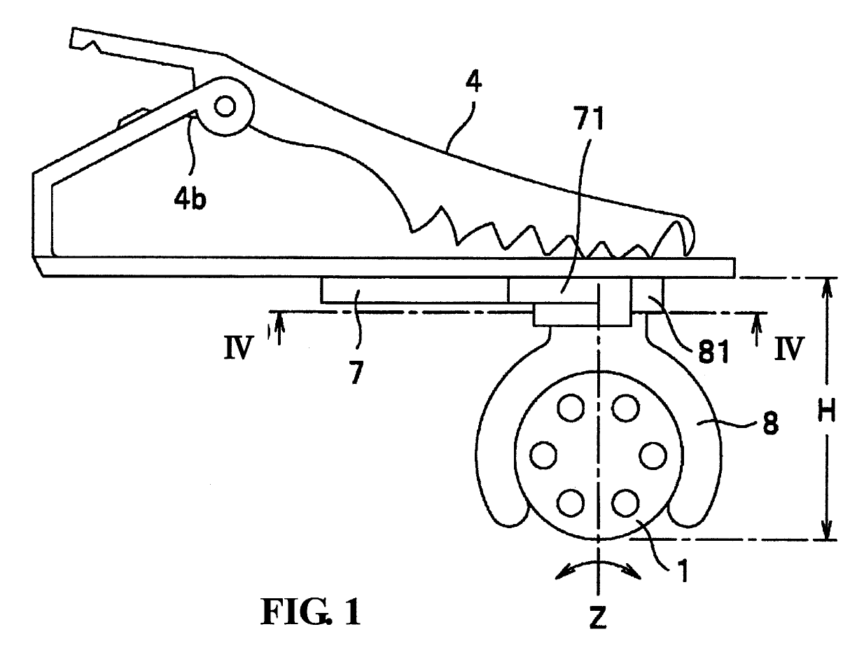

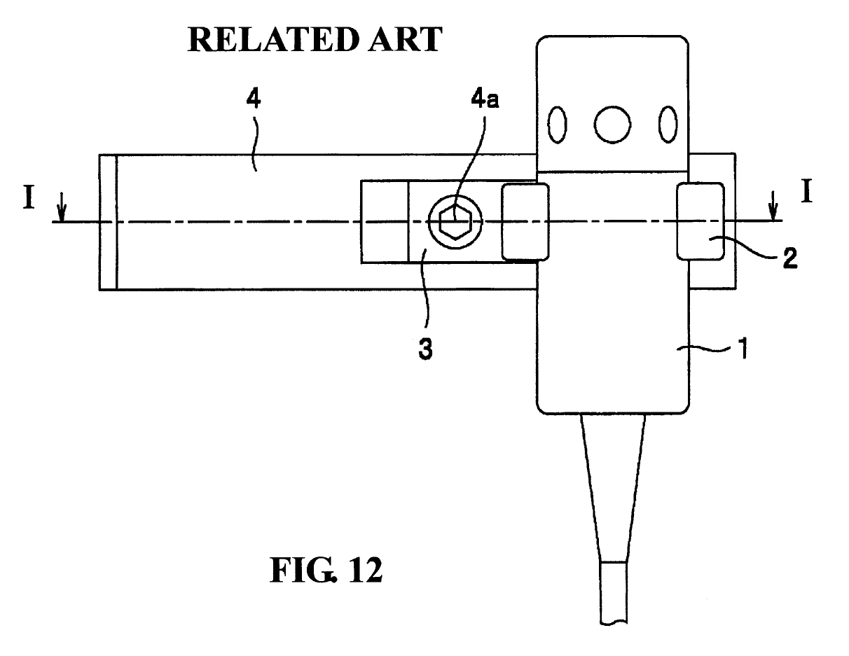

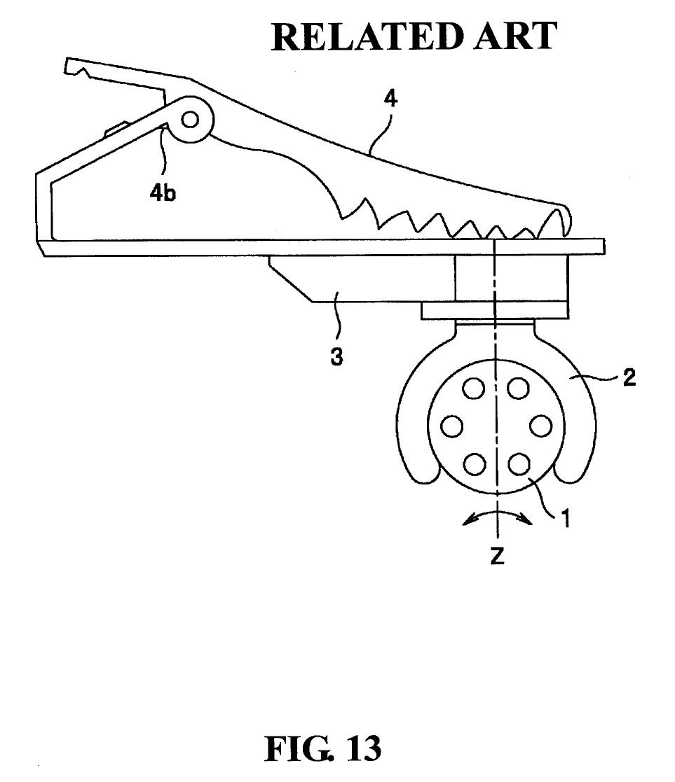

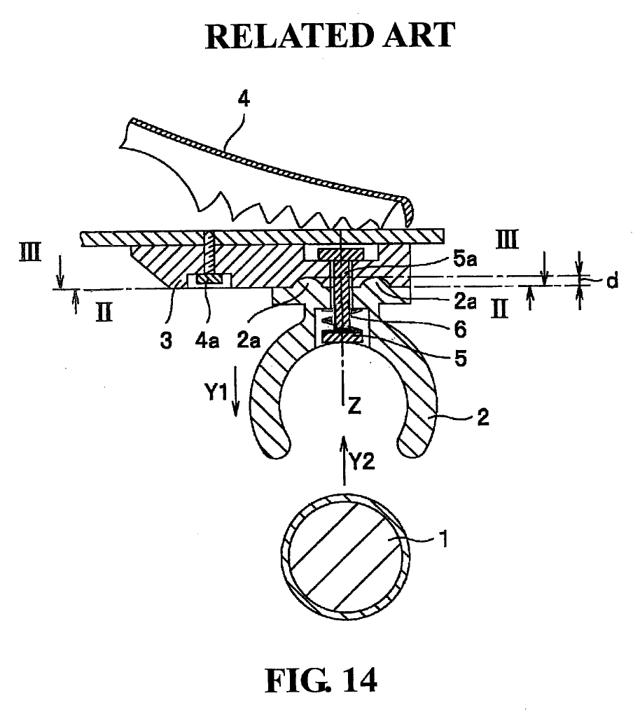

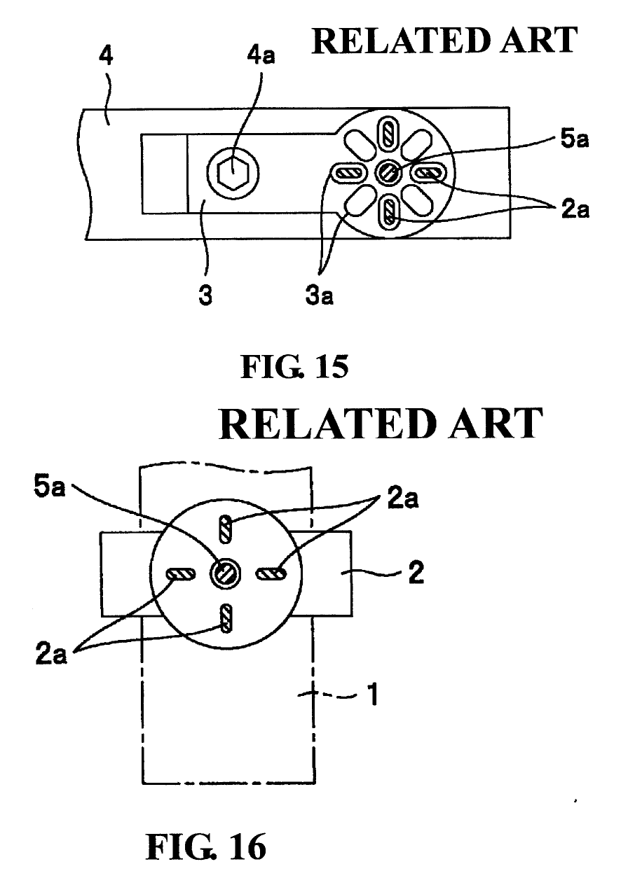

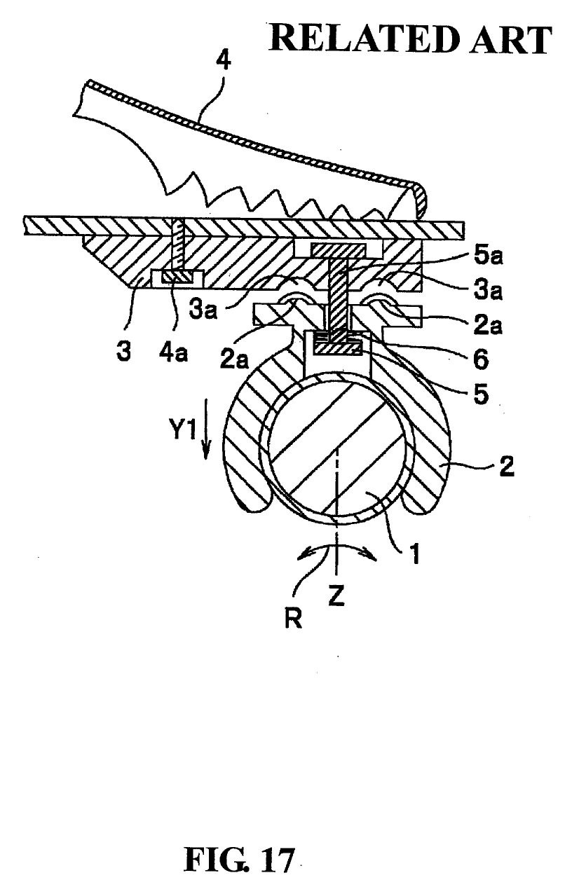

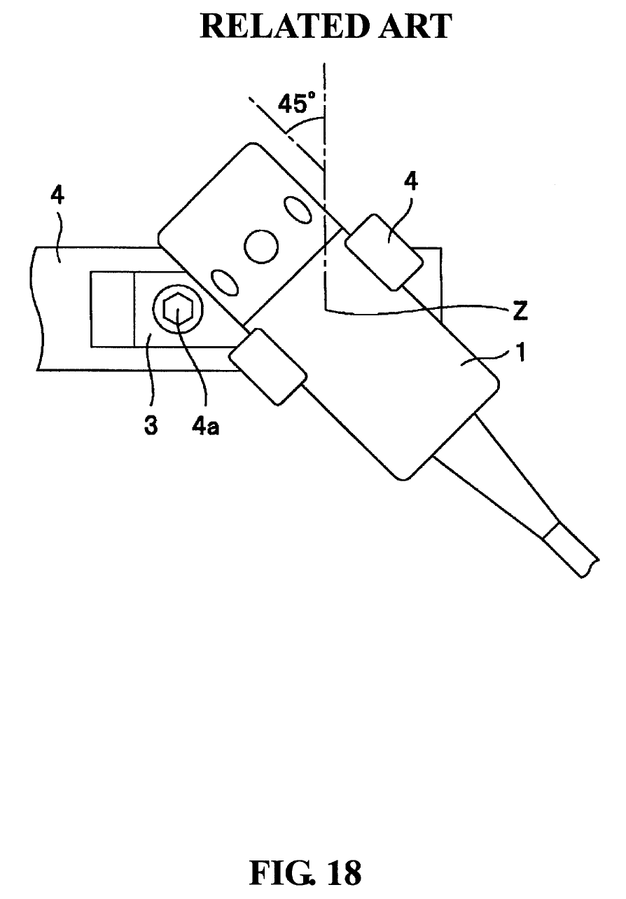

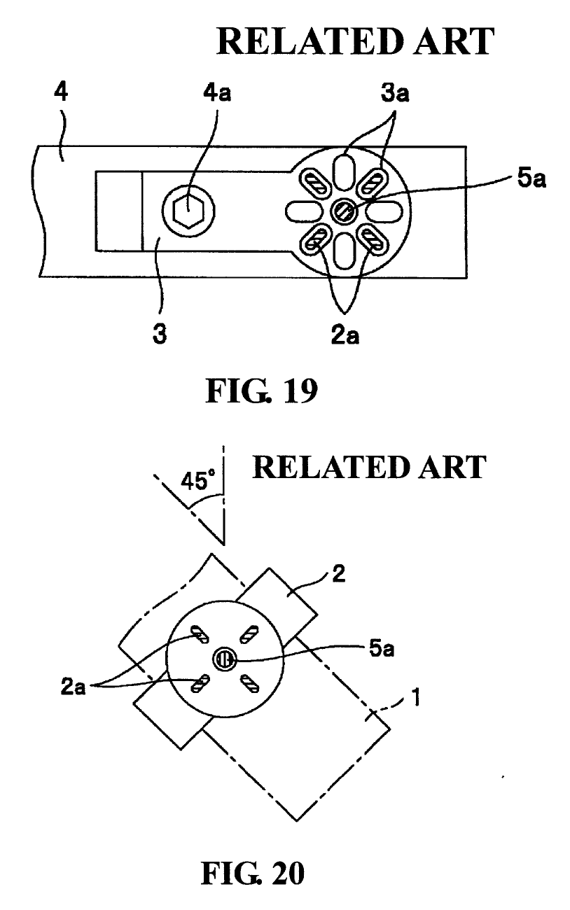

Embodiments of a microphone holder according to the present invention are described in detail with reference to FIGS. 1 to 11. Elements with configurations similar to that of the conventional microphone holder shown in FIGS. 12 to 20 are given the same reference numerals and detailed descriptions thereof are omitted.

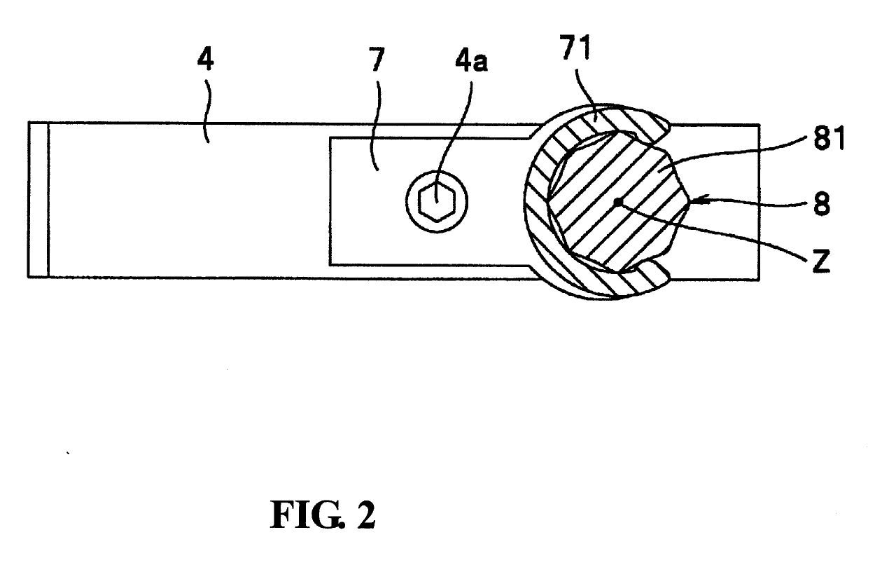

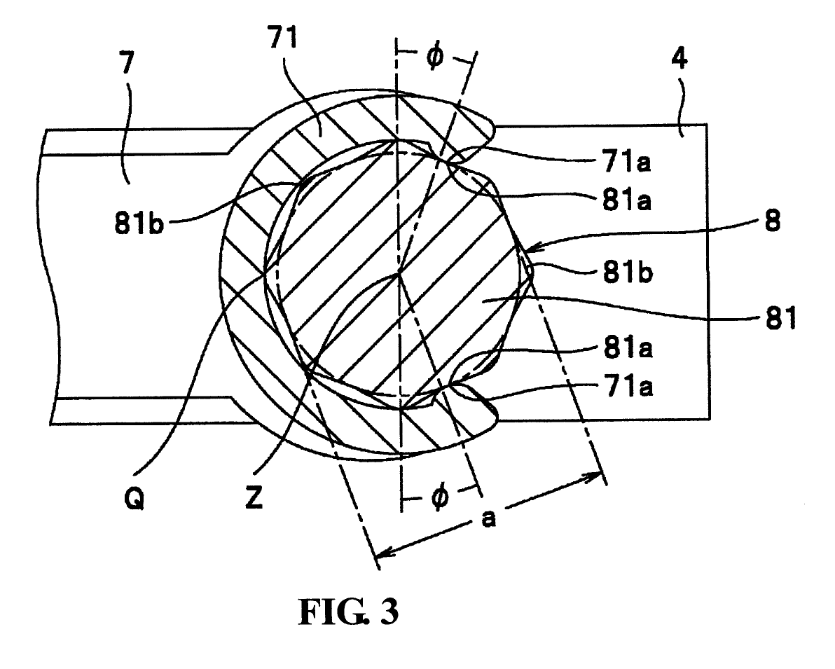

FIG. 1 is a plan view of a microphone holder of a first embodiment according to the present invention. FIG. 2 is a cross sectional view taken in the direction of arrows IV-IV of FIG. 1. FIG. 3 is an enlarged view of a main part of FIG. 2.

The microphone holder of the first embodiment shown in FIGS. 1 to 3 includes a clip 4 fixed to a plate-shaped holder base 7 with a bolt 4a and a microphone holding unit 8 holding a microphone 1 and being connected to the holder base 7.

The holder base 7 is made of a polyacetal resin having high lubricity. As shown in FIGS. 2 and 3, the holder base 7 includes a clamping unit 71 composed of a pair of bent arms provided at one longitudinal end thereof. Opposing convex portions 71a, 71a pointing inwardly are formed on opposing surfaces at tips of the bent arms.

As shown in FIG. 1, the microphone holding unit 8 is furcated. The microphone 1 is mounted to the furcated microphone holding unit 8 by pushing and opening the microphone holding unit 8. The microphone holding unit 8 can hold the microphone 1 with its elastic force.

As shown in FIGS. 1 to 3, the microphone holding unit 8 has a rotational shaft 81 that can fit into the clamping unit 71 through pushing and opening the clamping unit 71 of the holder base 7. The rotating shaft 81 has, on an outer periphery surface thereof, concave portions 81a, 81a and convex portions 81b alternately formed at 45° pitch. The concave portions 81a, 81a and the convex portions 81b are continuously formed to draw a smooth curb. The convex portions 71a, 71a of the clamping unit 71 can smoothly fit the concave portions 81a, 81a, at various rotational angular positions of the rotational shaft 81.

In other words, as shown in FIG. 3, the rotational shaft 81 of the microphone holding unit 8 has eight concave portions and eight convex portions alternately arranged at an even pitch. Thus, the clamping unit 71 of the holder base 7 can stably hold the microphone holding unit 8 by fitting the convex portions 71a, 71a in the concave portions 81a, 81a at positions shifted for an angle φ (22.5°) with respect to the vertical direction of the rotational shaft 81 as viewed in the figure.

With the elastic force of the clamping unit 71 of the holder base 7, the convex portions 71a, 71a smoothly correspond to the movement of the convex portions 81b, 81b and the concave portions 81a, 81a (that is, peak portions and trough portions) due to the rotation of the rotational shaft 81. In the present invention, the rotational shaft 81 of the microphone holding unit 8 is formed of polycarbonate resin that is a material different from that of the highly lubricant holder base 7. In addition, the convex portions 81b and the concave portions 81a, 81a are continuously formed to draw a smooth curve. Thus, excellent slidability and frictional performance are provided between the holder base 7 and the rotational shaft 81.

As shown in FIG. 3, with the elastic force of the clamping unit 71, the convex portions 71a, 71a fit into the concave portions 81a, 81a (at positions shifted for an angle φ (22.5°) viewed from the direction of the rotational shaft 81 as viewed in the figure) to apply force thereto in the inner direction. Thus, a curved bottom Q of the clamping unit 71 is in contact with the tip (at the left as viewed in the figure) of the rotational shaft 81 of the microphone holding unit 8. Accordingly, as being held at three points (three positions) under a constant pressure by the clamping unit 71 of the holder base 7, the rotational shaft 81 is stably held in a balanced manner. Note that though it may not be clear in the figure, the rotational shaft 81 and the clamping unit 71 is in contact with each other at the three points and thus, there are spaces between the inner surface of the clamping unit 71 and the convex portions 81b inside the clamping unit 71 but not in contact therewith.

The curved bottom Q of the clamping unit 71 of the holder base 7 draws a smooth curve, and line contacts with one of the convex portions 81b of the rotational shaft 81 so that the convex portion 81b is stably held. A concave portion that can receive the convex portion 81b of the rotational shaft 81 may be formed at the curved bottom Q so that the microphone holding unit 8 is more stably held.

Upon changing the number (i.e., the angular pitch) of the convex portions and the concave portions on the peripheral surface of the rotational shaft 81 of the microphone holing unit 8, the positions of the convex portions 71a, 71a of the clamping unit 71 should be changed to correspond thereto.

A numeral H in FIG. 1 represents the height from the clip 4 to the tip of the microphone 1. A numeral a in FIG. 3 represents a diameter of the rotational shaft 81 having the concave portions 81a, 81a.

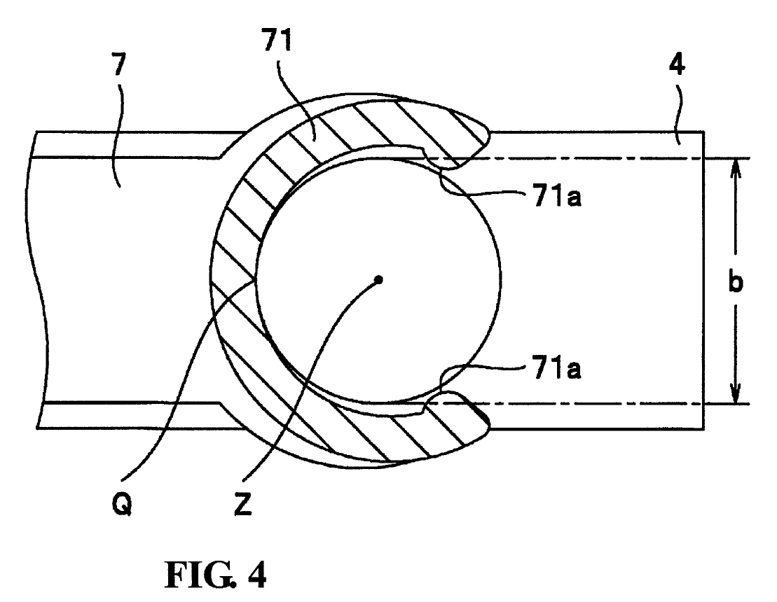

FIG. 4 is a front view depicting a state of the clamping unit 71 of the holder base 7 not holding the microphone holding unit 8. The holder base 7 stably holds the microphone holding unit 8 under a condition of b<a, where: b represents a diameter of a circle drawn along tip surfaces (in a tangential direction) of the convex portions 71a, 71a and the curved bottom Q of the clamping unit 71; and a represents the diameter of a circle drawn along each concave portion of the rotational shaft 81 of the microphone holding unit 8.

In the above description, the holder base 7 is made of polyacetal resin while the rotational shaft 81 of the microphone holding unit 8 is made of polycarbonate resin. Instead, the holder base 7 may be made of polycarbonate resin while the microphone holding unit 8 is made of polyacetal resin.

All things considered, in the microphone holder of the present embodiment, upon click rotating the microphone holding unit 8 about the rotational center axis (Z) of the rotational shaft 81, the convex portions 71a, 71a of the clamping unit 71 of the holder base 7 sequentially and smoothly fit into the concave portions 81a, 81a formed at the outer periphery surface of the rotational shaft 81 of the microphone holding unit 8.

Accordingly, the microphone holding unit 8 is click rotated through smooth sliding between: the concave and convex portions (81a and 81b) formed at the outer peripheral surface of the rotational shaft 81 of the microphone holding unit 8; and the convex portions 71a, 71a of the clamping unit 71 of the holder base 7. Thus, the generation of noise can be made small.

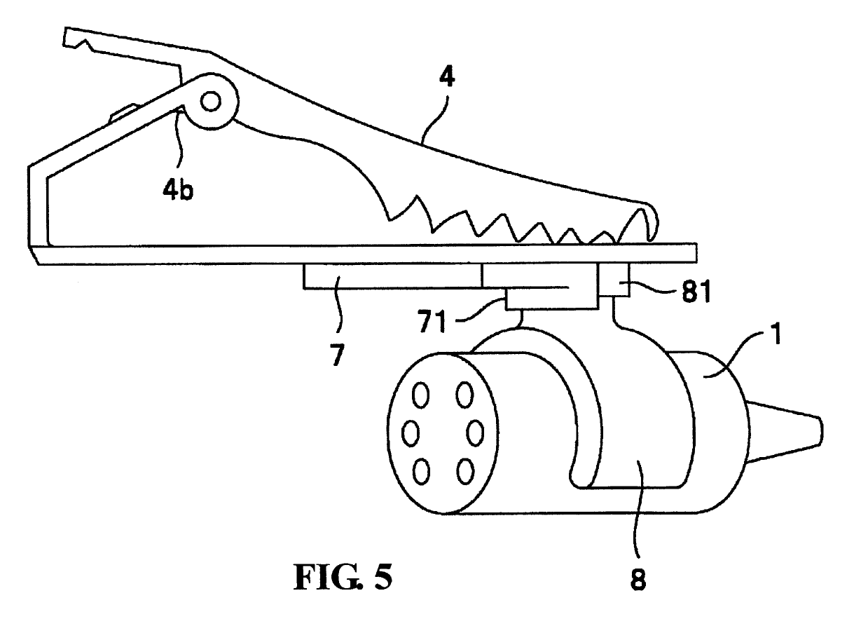

The user of the microphone holder can easily adjust the sound collecting direction of the microphone 1 to the direction depicted in the plan view in FIG. 5 only with the click rotation.

Further, no long loosely inserted bolt shaped connecting fitting 5 is included in an axial direction of the microphone holding unit 8 of the present embodiment. Thus the height H from the clip 4 to the tip of the microphone 1 can be made small as shown in FIG. 1. Consequently, the microphone holder as a whole can be downsized.

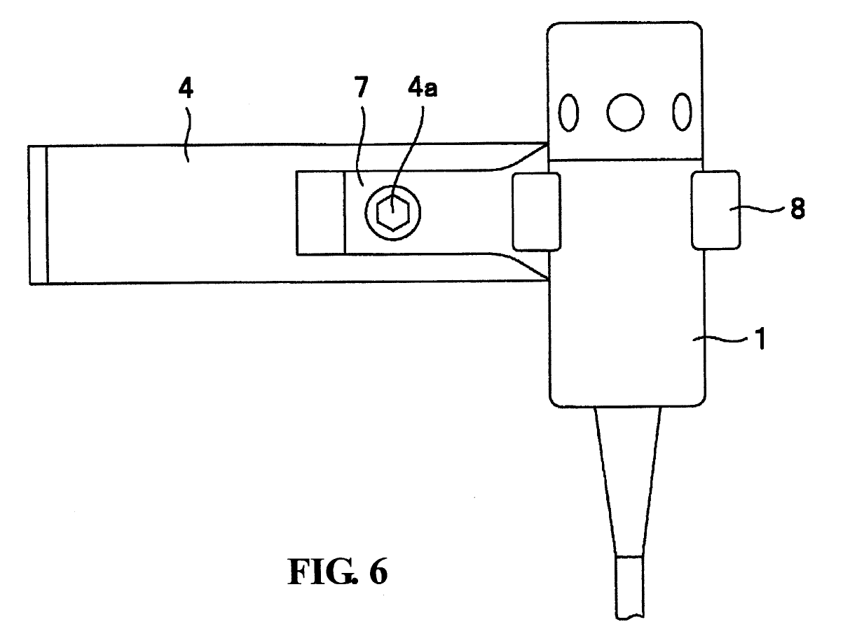

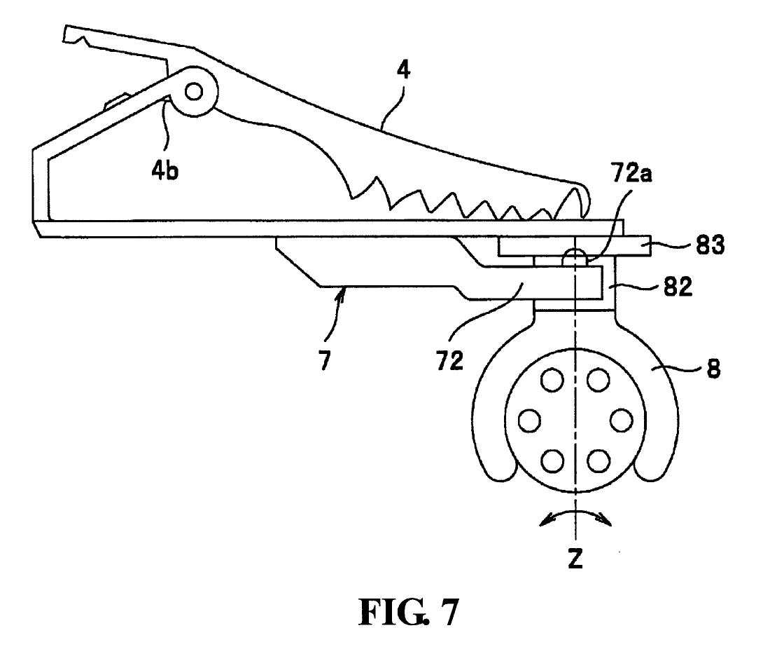

A microphone holder of a second embodiment of the present invention is described with reference to FIGS. 6 to 11. FIG. 6 is a front view of the microphone holder according to the second embodiment and FIG. 7 is a plan view thereof. The difference between the microphone holder of the first embodiment and that of the second embodiment lies in the configurations of the holder base 7 and the microphone holding unit 8. The following description focuses on the difference.

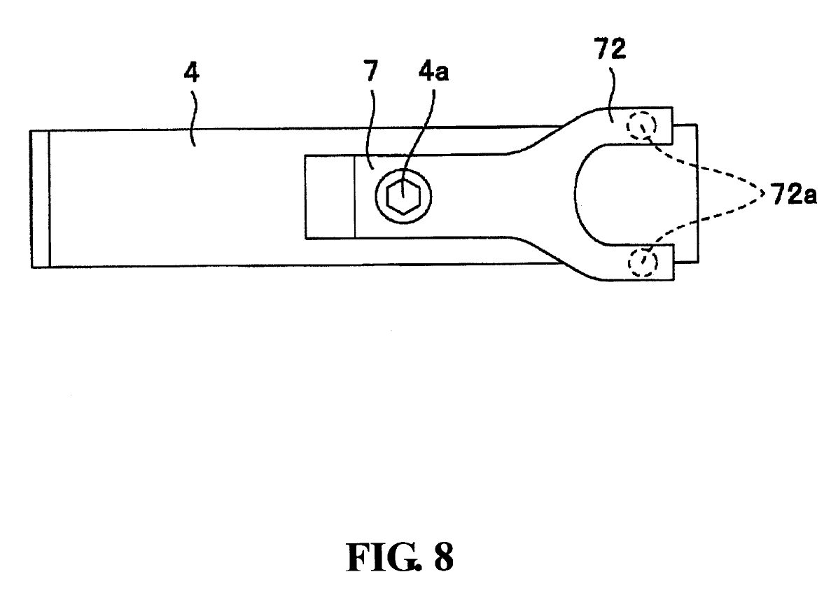

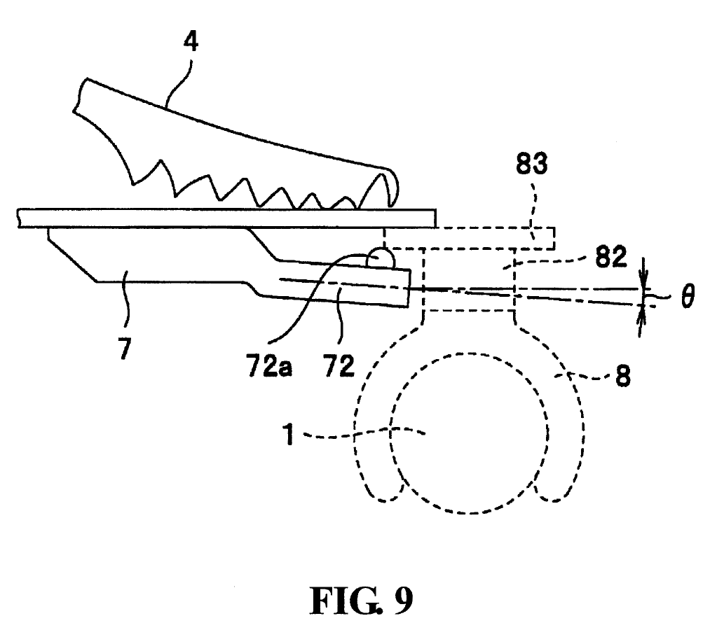

FIG. 8 is a front view of the holder base in FIG. 6 and FIG. 9 is a plan view of the main part thereof. As shown in the figures, the plate-shaped holder base 7 of the microphone holder according to the second embodiment has a U-shaped clamping unit 72 opening at one end in the longitudinal direction and having convex portions 72a on a rear surface of the tips thereof. The U-shaped clamping unit 72 has elastic force in an anteroposterior direction (i.e., towards the clip 4).

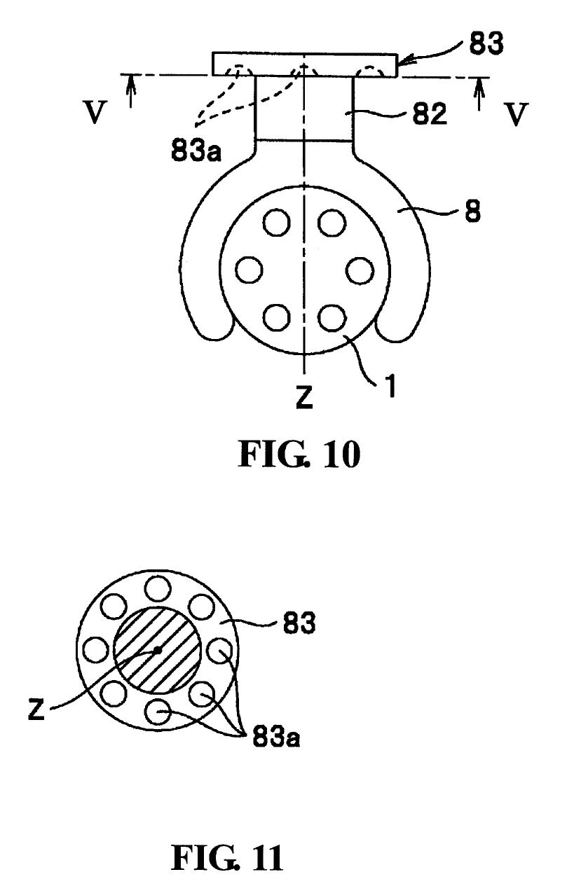

Meanwhile, as shown in a plan view of FIG. 10, the microphone holding unit 8 has a rotational shaft 82 and a disk shaped flange 83 fixed to one end of the rotational shaft 82. As shown in FIG. 11, which is a cross sectional view taken in the direction of arrows V-V of FIG. 10, a plurality of concave portions 83a are circumferentially formed on the flange 83. The position at which the smooth concave portions 83a are arranged so that the concave portions 72a of the U-shaped clamping unit 72 can fit into the concave portions 83a at a required rotational angular position of the rotational shaft 82.

As shown in FIG. 9, the rotational shaft 82 of the microphone holding unit 8 can be fit into the U-shaped elastic clamping unit 72 of the holder base 7 by warping the clamping unit 72 for an angle θ. As the rotational shaft 82 fits into the clamping unit 72, the convex portions 72a of the U-shaped clamping unit 72 are fit into the concave portions 83a of the flange 83. Thus, the microphone holding unit 8 and the holder base 7 are stably connected.

In FIG. 11, the flange 83 of the microphone holding unit 8 of this embodiment has eight concave portions 83a formed radially with respect to the rotational center axis (Z). The number of the convex portions 83a can be set as required as long as the positions of the concave portions 83a correspond to the angular position of the convex portions 72a, 72a of the U-shaped clamping unit 72 of the holder base 7.

As shown in FIG. 7, also with the microphone holder according to the second embodiment, the sound collecting direction of the microphone 1 can be easily adjusted only through a click rotation about the rotational center axis (Z) of the microphone holding unit 8 held by the holder base 7.

In the present embodiment, the holder base 7 is made of polyacetal resin while the flange 83 of the microphone holding unit 8 is made of polycarbonate resin. Instead, the holder base 7 can be made of polycarbonate resin while the flange 83 of the microphone holding unit 8 is made of polyacetal resin.

As described above, the user of the microphone holder according to the second embodiment attached to his or her clothes can adjust the sound collecting direction of the microphone 1 only through the click rotation of the microphone holding unit 8. In addition, the click rotation of the microphone holding unit 8 is accompanied by the fitting of the convex portions 72a of the holder base 7 into the concave portions 83a on the flange 83 of the microphone holding unit 8 through smooth sliding. Thus, the generation of noise is reduced or eliminated so that no noise is picked up by the microphone 1.

The rotational shafts 81 and 82 of the above embodiments have a shape of a rod. Instead, the rotational shafts 81 and 82 may be a cylinder.

All things considered, with the microphone holders according to the above embodiments having simple structures and small sizes, connection angle of the microphone holding unit and the holder base can be adjusted through smooth sliding. Thus, the generation of noise can be substantially reduced. Moreover, as the user can easily adjust the sound collecting direction through a simple operation of rotating the microphone holding unit, the microphone holders are remarkably advantageous in actual use.

With the microphone holder according to the present invention, at lectures, conferences, or the like, performers and lecturers can wear the lavaliere microphone on their clothes, ties, and the like. Moreover, the direction of the microphone can easily be adjusted through adjusting an angular positional relationship between the microphone holding unit and the holder base. Further, generation of noise generated upon adjusting the direction of the microphone can be avoided.

What is claimed is:

1. A microphone holder including a clip fixed to a plate-shaped holder base and a microphone holding unit connected to the holder base and capable of holding a microphone, wherein
the holder base has a clamping unit having bent arms of which facing tip ends each having a convex portion,
the microphone holding unit has a rotational shaft capable of fitting into the clamping unit of the holder base while pushing and opening the tip ends of the bent arms, and
the rotational shaft has a plurality of concave portions on a peripheral surface of the rotational shaft that can receive the convex portion of the clamping unit at various rotational angular positions of the rotational shaft.

2. The microphone holder according to claim 1, wherein the clamping unit of the holder base holds the rotational axis of the microphone holding unit at three points.

3. The microphone holder according to claim 1, wherein the clamping unit of the holder base has a concave portion at a curved bottom of the clamping unit that receives a part of a peripheral surface of the rotational shaft of the microphone holding unit.

4. The microphone holder according to claim 2, wherein the clamping unit of the holder base has a concave portion at a curved bottom of the clamping unit that receives a part of the peripheral surface of the rotational shaft of the microphone holding unit.

5. The microphone holder according to claim 1, wherein the clamping unit of the holder base and the rotational shaft of the microphone holding unit are made of different materials.

6. A microphone holder including a clip fixed to a plate-shaped holder base and a microphone holding unit connected to the holder base and capable of holding a microphone, wherein
the holder base has a U-shaped clamping unit opening at one end of a longitudinal direction and having a convex portion at a rear surface of the U-shaped clamping unit, and
the microphone holding unit comprises:
a rotational shaft that can be fit into the U-shaped clamping unit of the holder base; and
a flange having a plurality of concave portions circumferentially arranged to be able to receive the convex portion of the U-shaped clamping unit at various rotational angular positions of the rotational shaft.

7. The microphone holder according to claim 6, wherein the U-shaped clamping unit of the holder base and the rotational shaft of the microphone holding unit are made of different materials.
